(19) United States
(12) Patent Application Publication
(10) Pub. No.: US 2026/0369795 A1
(43) Pub. Date: Nov. 19, 2026

(54) ELECTRIC VEHICLE BATTERY PACK DEGAS UNIT

(71) Applicant: FCA US LLC, Auburn Hills, MI (US)

(72) Inventors: William W. MU, Auburn Hills, MI (US); Qingyuan TAN, Windsor (CA)

(21) Appl. No.: 19/211,499

(22) Filed: May 19, 2025

(51) Int. Cl. H01M 50/333; H01M 50/204; H01M 50/24; H01M 50/249; H01M 50/30

(52) U.S. Cl. CPC H01M 50/333; H01M 50/24; H01M 50/249; H01M 50/394; H01M 50/204

(57) ABSTRACT

A degassing unit configured for use in a battery pack to relieve pressure in the battery pack, which includes a first valve unit and a second valve unit. The first valve unit includes a vapor block member that permits gases within the interior of the battery pack to exit the battery pack to control pressure fluctuations in the housing during normal operating conditions and prevent the ingress of the liquid to the battery pack from an exterior of the housing. The second valve unit is mated with and movable relative to the first valve unit between a closed position and an open position. The second valve unit is in the closed position under the normal operating conditions, and the second valve unit is in the open position under emergency operating conditions where pressure within the housing needs to be immediately released.

### FIELD

The present disclosure relates to electric vehicles and, more particularly, to electrical vehicle battery packs with a degassing unit.

### BACKGROUND

This section provides background information related to the present disclosure which is not necessarily prior art.

Battery housings cannot be completely closed due to the fact that temperature fluctuates in the housing. This is generally caused by the charging and discharging of the battery cells, and due to compressed air fluctuations. Other scenarios, such as altitude change, driving through a tunnel, etc., may result in significant pressure differences inside and outside of the sealed battery housing. Thus, a gas exchange between an interior of the housing and an exterior of the housing must occur to prevent loads on the housing. Such loads can result in bursting or bulging of the housing if too much compressed gas is present in the housing. Also, it is important that dirt and moisture do not enter into the housing when the compressed gas is enabled to exit the housing. The entrance of water vapor, such as liquid water, may damage the electrical system and in a worst case, cause a short circuit fault.

Gassing devices are known that include semi-permeable membranes that are gas permeable, but not liquid permeable. Battery packs that may include a gassing device are configured to regularly equalize internal pressure with the external atmosphere to minimize mechanical stress on the battery pack to ensure optimal performance longevity. These degassers may also function as a vent during thermal runaway events to release internal gases to prevent potential battery rupture. The pressure balancing function, however, is often implemented using PTFE or E-PTFE materials which allow for water vapor intrusion under humid conditions. This moisture ingress can lead to loss of electrical insulation, battery corrosion, or damage to battery components. These membranes, therefore, may present a moisture intrusion vulnerability.

### SUMMARY

This section provides a general summary of the disclosure, and is not a comprehensive disclosure of its full scope or all of its features.

According to a first aspect of the present disclosure, there is provided a battery pack for a vehicle that includes a housing configured to house a plurality of battery cells within an interior thereof; and at least one aperture provided in the housing that includes a degassing unit that includes a first valve unit and a second valve unit, wherein the first valve unit is seated in the aperture and includes a vapor block member that permits gases within the interior of the battery pack to exit the battery pack to control pressure fluctuations in the housing during normal operating conditions and prevent liquids and water vapor from entering the battery pack from an exterior of the housing; the second valve unit is mated with and movable relative to the first valve unit between a closed position and an open position, and the second valve unit is in the closed position under the normal operating conditions, and the second valve unit is in the open position under emergency operating conditions where pressure within the housing needs to be immediately released.

According to the first aspect, the second valve unit includes a disk having a stem projecting outward therefrom that is mated with and movable relative to the first valve unit.

According to the first aspect, the disk includes an elastomeric seal member that seats against the first valve unit when the second valve unit is in the closed position to seal the aperture while permitting the gases within the interior of the battery pack to exit the battery pack through the first valve unit to control pressure fluctuations in the housing during the normal operating conditions.

According to the first aspect, the stem includes a proximate end attached to the disk and a distal end that defines a radially outwardly extending flange.

According to the first aspect, a spring is positioned between the radially outwardly extending flange and the first valve unit that biases the second valve unit to the closed position during the normal operating conditions.

According to the first aspect, the distal end of the stem is hollow to define a pressure receiving surface therein that actuates the second valve unit to the open position under the emergency operating conditions to immediately release the pressure within the housing.

According to the first aspect, the disk is made of an impervious material.

According to a second aspect of the present disclosure, there is provided a degassing unit configured for use in a battery pack to relieve pressure in the battery pack while preventing the ingress of liquid into the battery pack. The degassing unit may include a first valve unit; and a second valve unit, wherein the first valve unit is configured to be seated in an aperture of a housing of the battery pack, and includes a vapor block member that permits gases within the interior of the battery pack to exit the battery pack to control pressure fluctuations in the housing during normal operating conditions and prevent the ingress of the liquid to the battery pack from an exterior of the housing; the second valve unit is mated with and movable relative to the first valve unit between a closed position and an open position, and the second valve unit is in the closed position under the normal operating conditions, and the second valve unit is in the open position under emergency operating conditions where pressure within the housing needs to be immediately released.

According to the second aspect, the second valve unit includes a disk having a stem projecting outward therefrom that is mated with and movable relative to the first valve unit.

According to the second aspect, the disk includes an elastomeric seal member that seats against the first valve unit when the second valve unit is in the closed position to seal the aperture while permitting the gases within the interior of the battery pack to exit the battery pack through the first valve unit to control pressure fluctuations in the housing during the normal operating conditions.

According to the second aspect, the stem includes a proximate end attached to the disk and a distal end that defines a radially outwardly extending flange.

According to the second aspect, the degassing unit may further include a spring positioned between the radially outwardly extending flange and the first valve unit that biases the second valve unit to the closed position during the normal operating conditions.

According to the second aspect, the distal end of the stem is hollow to define a pressure receiving surface therein that actuates the second valve unit to the open position under the emergency operating conditions to immediately release the pressure within the housing.

According to the second aspect, the disk is made of an impervious material.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a partial schematic perspective view of a example battery pack having a degassing unit according to a principle of the present disclosure;

FIG. 2 is a cross-sectional view along line 2-2 of FIG. 1 showing the degassing unit in a closed position; and

FIG. 3 is a cross-sectional view of the degassing unit shown in FIG. 2 in an open position.

Corresponding reference numerals indicate corresponding parts throughout the several views of the drawings.

### DETAILED DESCRIPTION

Example embodiments will now be described more fully with reference to the accompanying drawings.

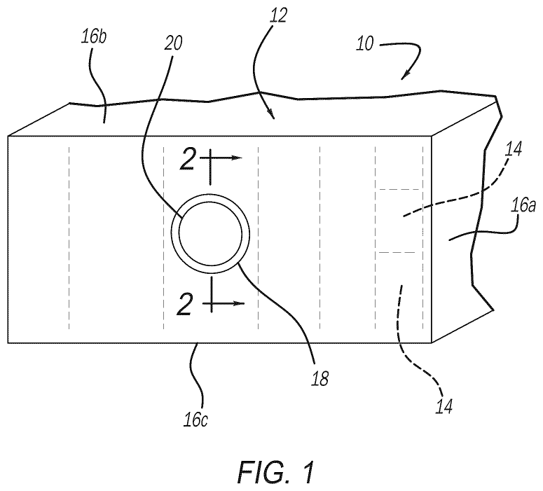

An example battery pack is illustrated in FIG. 1 and is designated with the reference numeral 10. The battery pack 10 includes a housing 12 that may be formed of a rigid and puncture-resistant material such as aluminum, steel, or some other type of metal material. Housing 12 may also be formed of a rigid and puncture-resistant polymeric material (e.g., glass-reinforced polyamide (NYLON®) without departing from the scope of the present disclosure Generally, the housing 10 may be rectangular structure that is configured to store a plurality of battery cells 14. The housing 12 includes a perimeter wall 16a, a top panel 16b attached to the perimeter wall 16a, and a bottom panel 16c attached to the perimeter wall 16a. While an aperture 18 that receives a degassing unit 20 is illustrated as being provided in perimeter wall 16a, it should be understood that housing 12 may include a plurality of apertures 18 that receive a corresponding degassing unit 20, and that top panel 16b and bottom panels 16c may also include apertures 18 that receive a corresponding degassing unit 20.

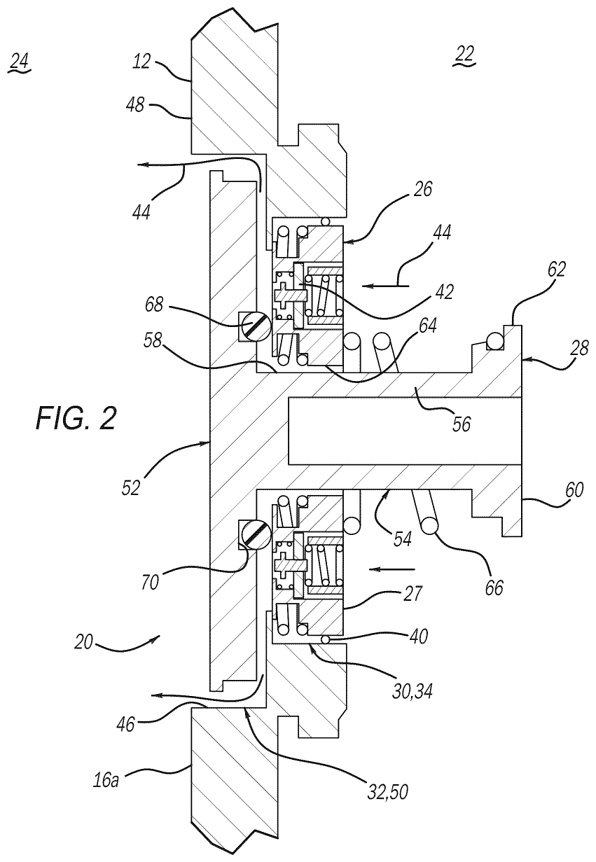

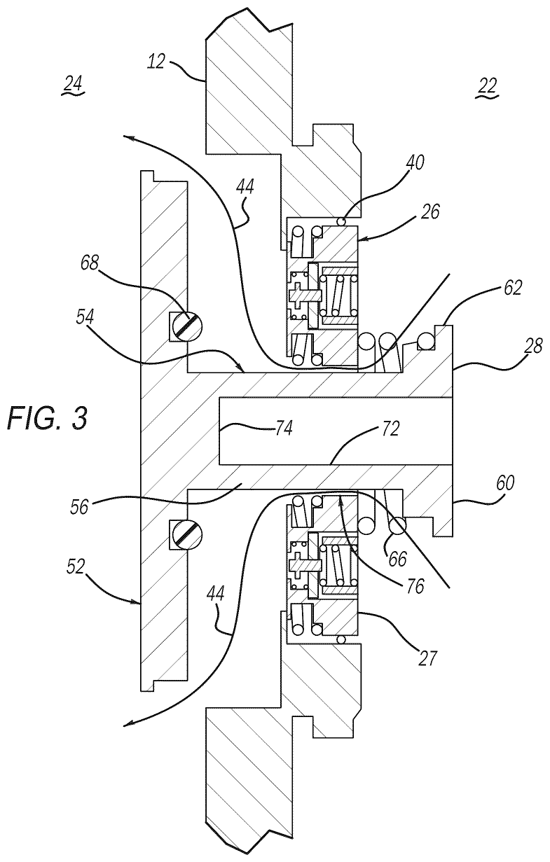

Now referring to FIGS. 2 and 3, it can be seen that the degassing unit 20 is provided in the aperture 18 of the housing wall 16a, and is configured to prevent ingress of liquid or water vapor into an interior 22 of housing 12 from the environment 24 located exterior to housing 12 (FIG. 2) when degassing unit 20 is in a closed position and battery pack 10 is operating under normal operating conditions, and permit excessive pressure to be relieved from the housing 12 under various operating conditions (FIG. 3). In this regard, the degassing unit 20 includes a first valve unit 26 that is configured to prevent the ingress of liquid water and water vapor into the interior 22 of housing 12 and a second valve unit 28 that is configured to permit excessive pressure to be relieved from the interior 22 of the housing 12 under the various operating conditions.

To accommodate each of the first valve unit 26 and the second valve unit 28, it can be seen in FIG. 2 that the aperture 18 includes a first section 30 and a second section 32, wherein first section 30 is located within the interior 22 of housing 12 and serves as a first seat 34 for the first valve unit 26. First section 30 and second section 32 may be formed by a material that forms the perimeter wall 16a of housing 12. Alternatively, only second section 32 is formed by the material that forms the perimeter wall 16a and the first section 30 is formed from an annular insert (not shown) that is welded, brazed, or adhered to the aperture 18 formed in the perimeter wall 16a. In either case, first section 30 includes a first axially extending surface 36 that terminates at a radially inwardly extending wall 38, and the combination of first axially extending surface 36 and radially inwardly extending wall 38 collectively define the first seat 34 for first valve unit 26. A first elastomeric seal member 40 may be provided between first valve unit 26 and axially extending surface 36.

First valve unit 26 is an annular device that includes a valve body 27 that supports an annular water vapor block member 42 that may be formed of, for example, a graphene-based material or a metal organic framework. First valve unit 26, therefore, is configured to permit air 44 within interior 22 of housing 12 to exit first valve unit 26 through the water vapor block member 42 during normal operating conditions of battery pack 10, while preventing the ingress of water and water vapor into the interior 22 of housing 12 during the normal operating conditions (FIG. 2).

Second section 32 includes a second axially extending surface 46 that extends between an exterior surface 48 of perimeter wall 16a and radially inwardly extending wall 38, with the combination of second axially extending surface 46 and radially inwardly extending wall 38 collectively defining a second seat 50 for second valve unit 28. As noted above, second valve unit 28 is configured to release excessive pressure that may develop within the interior 22 of housing 12 during various operating conditions (for example, during a thermal runaway event).

Second valve unit 28 may include a disk 52 that is configured to seat against radially inwardly extending wall 38 when second valve unit 28 is in the closed position (FIG. 2) and be spaced apart from the radially inwardly extending wall 38 when the second valve unit 28 is in the open position (FIG. 3). A stem 54 is connected to disk 52 and extends axially outward from the disk 52 such that a majority of the stem 54 is positioned within the interior 22 of housing 12 during normal operating conditions (FIG. 2).

Stem 54 includes a hollow stem body 56 having a proximate portion 58 attached to disk 52 and a distal end 60 that defines a radially outwardly extending flange 62. Hollow stem body 56 is configured to pass through and be spaced apart from a central aperture 64 provided in valve body 27 of first valve unit 26. A spring 66 may be positioned between valve body 27 of first valve unit 27 and radially outwardly extending flange 62 that simultaneously biases disk 52 and valve body 27 toward radially inwardly extending wall 38.

Disk 52 has a desired configuration (e.g., circular) and may be formed from a solid impervious material such as a metal or polymeric material. The disk 52 is devoid of any membrane material that can permit water and water vapor from passing therethrough. A second elastomeric seal member 68 may seated in an annular groove 70 provided in disk 52 that seats against valve body 27 of first valve unit 26 (FIG. 2). Notably, the second elastomeric seal member 68 is provided radially inward from the annular water vapor block member 42 so that when first valve unit 28 is in the closed position (FIG. 2), air 44 is still permitted to travel from the interior 22 of housing 12 to the exterior environment 24 as necessary during normal operating conditions while still preventing the ingress of water and water vapor from the exterior environment 24 into the interior 22 of housing 12.

Second valve unit 28 is configured to open (FIG. 3) when operating conditions within housing 12 grow to an extent where pressure within housing 12 needs to be relieved (i.e., emergency operating conditions). To permit second valve unit 28 to open, hollow stem body 56 includes an opening or recess 72 that extends along a length of hollow stem body 56 and terminates at an interior surface 74 of hollow stem body 56 that serves as a pressure application surface. Put another way, as pressure develops within housing 12 during various operating conditions that require battery pack 12 to be vented (e.g., during thermal runaway), the excess pressure can impinge on the interior surface 74 and as the pressure increases, the pressure can exceed that exerted by spring 66 and force disk 52 away from engagement with valve body 27 of first valve unit 26. As disk 52 and second annular seal member 68 separate from first unit 26, the excessive pressure present within interior 22 of housing is permitted to exit the housing 12 through the small gap 76 between stem 54 and valve body 27 of first valve unit 26 to quickly depressurize the interior 22 of housing 12. This may occur at pressures within housing 12 of, for example, 100 millibars.

Thus, degassing unit 20 of the present disclosure includes a first valve unit 26 and a second valve unit 28 that cooperate to permit air 44 to exit the housing 12 during normal operating conditions as may be required during normal operation of battery pack 12, while preventing moisture and water vapor from entering the housing 12 (FIG. 2). When the operating conditions within housing 12 reach a point that is considered excessive to normal operating conditions (i.e., during thermal runaway), the second valve unit 28 is configured to open and permit the pressuring increasing within housing 12 to be released.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A battery pack for a vehicle, comprising:
a housing configured to house a plurality of battery cells within an interior thereof; and
at least one aperture provided in the housing that includes a degassing unit that includes a first valve unit and a second valve unit,
wherein the first valve unit is seated in the aperture and includes a vapor block member that permits gases within the interior of the battery pack to exit the battery pack to control pressure fluctuations in the housing during normal operating conditions and prevent liquids and water vapor from entering the battery pack from an exterior of the housing;
the second valve unit is mated with and movable relative to the first valve unit between a closed position and an open position, and
the second valve unit is in the closed position under the normal operating conditions, and the second valve unit is in the open position under emergency operating conditions where pressure within the housing needs to be immediately released.

2. The battery pack of claim 1, wherein the second valve unit includes a disk having a stem projecting outward therefrom that is mated with and movable relative to the first valve unit.

3. The battery pack according to claim 2, wherein the disk includes an elastomeric seal member that seats against the first valve unit when the second valve unit is in the closed position to seal the aperture while permitting the gases within the interior of the battery pack to exit the battery pack through the first valve unit to control pressure fluctuations in the housing during the normal operating conditions.

4. The battery pack according to claim 2, wherein the stem includes a proximate end attached to the disk and a distal end that defines a radially outwardly extending flange.

5. The battery pack according to claim 4, wherein a spring is positioned between the radially outwardly extending flange and the first valve unit that biases the second valve unit to the closed position during the normal operating conditions.

6. The battery pack according to claim 4, wherein the distal end of the stem is hollow to define a pressure receiving surface therein that actuates the second valve unit to the open position under the emergency operating conditions to immediately release the pressure within the housing.

7. The battery pack according to claim 1, wherein the disk is made of an impervious material.

8. A vehicle comprising the battery pack of claim 1.

9. A degassing unit configured for use in a battery pack to relieve pressure in the battery pack while preventing the ingress of liquid into the battery pack, comprising:
a first valve unit; and
a second valve unit,
wherein the first valve unit is configured to be seated in an aperture of a housing of the battery pack, and includes a vapor block member that permits gases within the interior of the battery pack to exit the battery pack to control pressure fluctuations in the housing during normal operating conditions and prevent the ingress of the liquid to the battery pack from an exterior of the housing;
the second valve unit is mated with and movable relative to the first valve unit between a closed position and an open position, and
the second valve unit is in the closed position under the normal operating conditions, and the second valve unit is in the open position under emergency operating conditions where pressure within the housing needs to be immediately released.

10. The degassing unit of claim 9, wherein the second valve unit includes a disk having a stem projecting outward therefrom that is mated with and movable relative to the first valve unit.

11. The degassing unit according to claim 10, wherein the disk includes an elastomeric seal member that seats against the first valve unit when the second valve unit is in the closed position to seal the aperture while permitting the gases within the interior of the battery pack to exit the battery pack through the first valve unit to control pressure fluctuations in the housing during the normal operating conditions.

12. The degassing unit according to claim 10, wherein the stem includes a proximate end attached to the disk and a distal end that defines a radially outwardly extending flange.

13. The degassing unit according to claim 12, further comprising a spring positioned between the radially outwardly extending flange and the first valve unit that biases the second valve unit to the closed position during the normal operating conditions.

14. The degassing unit according to claim 12, wherein the distal end of the stem is hollow to define a pressure receiving surface therein that actuates the second valve unit to the open position under the emergency operating conditions to immediately release the pressure within the housing.

15. The degassing unit according to claim 9, wherein the disk is made of an impervious material.

16. A battery pack comprising the degassing unit according to claim 9.

17. A vehicle comprising the battery pack according to claim 16.
